(19) United States
(12) Patent Application Publication
(10) Pub. No.: US 2026/0255376 A1
(43) Pub. Date: Aug. 27, 2026

(54) COMMUNICATION METHOD AND CHIP

(71) Applicant: SPREADTRUM COMMUNICATIONS (SHANGHAI) CO., LTD., Shanghai (CN)

(72) Inventors: Huayu ZHOU, Shanghai (CN); Zhengang PAN, Shanghai (CN)

(21) Appl. No.: 19/102,293

(22) PCT Filed: Aug. 11, 2023
(86) PCT No.: PCT/CN2023/112728

§ 371 Date: Feb. 7, 2025

(30) Foreign Application Priority Data
Aug. 12, 2022 (CN) 202210970233.9

(51) Int. Cl. H04W 72/51; H04W 56/00; H04W 72/0453

(52) U.S. Cl. CPC H04W 72/51; H04W 56/001; H04W 72/0453

(57) ABSTRACT

A communication method and a chip are provided. The method includes determining a frequency domain location of a non-cell defining (NCD)-synchronization signal/physical broadcast channel block (SSB) according to first configuration information.

### CROSS-REFERENCE TO RELATED APPLICATION(S)

This application is a National Stage of International Application No. PCT/CN2023/112728, filed Aug. 11, 2023, which claims priority to Chinese Patent Application No. 202210970233.9, filed Aug. 12, 2022, both of which are incorporated herein by reference in their entireties.

### TECHNICAL FIELD

The present disclosure relates to the field of communication technologies, and in particular, to a communication method and a chip.

### BACKGROUND

In machine type communication (MTC) or internet of things (IOT) technology, small data transmission (SDT) is an efficient transmission mode, i. e., when the data amount is relatively small, the terminal device can transmit and receive data in an inactive mode or inactive state or radio resource control (RRC)_inactive state, or in an idle mode or idle state or RRC_idle state, instead of entering a connected mode or connected state or RRC_connected state, so that frequent and a large number of RRC connection setup and release can be avoided, thereby not only reducing overhead of network signaling, but also reducing power consumption of terminal devices.

Generally, reduced capability (RedCap) user equipment (UE) can support SDT.

Generally, SDT can only be operated in an initial downlink (DL) bandwidth part (BWP), but the RedCap UE can use a RedCap UE specific initial DL BWP. Therefore, how the RedCap UE can use SDT in the RedCap UE specific initial DL BWP is an urgent problem to be solved.

### SUMMARY

Embodiments of the present disclosure provide a communication method and a chip.

According to a first aspect, embodiments of the present disclosure provide a communication method. The method includes determining a frequency domain location of a non-cell defining (NCD)-synchronization signal/physical broadcast channel block (SSB) according to first configuration information.

According to a second aspect, embodiments of the present disclosure provide a communication method. The method includes determining whether an NCD-SSB is valid according to first indication information.

According to a third aspect, embodiments of the present disclosure provide a communication method. The method includes receiving paging or system information block 1 (SIB1) or other system information (OSI) in a second initial DL BWP in a case where the first initial DL BWP does not contain a cell defining (CD)-SSB or control resource set zero (CORESENT#0), where a frequency location and bandwidth of the second initial DL BWP is the same as a frequency location and bandwidth of the CORESENT#0, or the frequency location and bandwidth of the second initial DL BWP is the same as a frequency location and bandwidth of a frequency span formed by the CD-SSB and the CORESENT#0.

According to a fourth aspect, the present disclosure provides a chip. The chip includes a processor and a communication interface. The processor is configured to cause the chip to execute the method in the first aspect, or the processor is configured to cause the chip to perform the method of the second aspect, or the processor is configured to cause the chip to perform a method of the third aspect.

### BRIEF DESCRIPTION OF THE DRAWINGS

FIG. 1 is a schematic diagram of a communication system according to embodiments of the present disclosure.

FIG. 2 is a schematic flow chart of a communication method according to embodiments of the present disclosure.

FIG. 3 is a schematic flow chart of another communication method according to embodiments of the present disclosure.

FIG. 4 is a schematic flow chart of another communication method according to embodiments of the present disclosure.

FIG. 5 is a schematic flow chart of another communication method according to embodiments of the present disclosure.

FIG. 6 is a schematic structural diagram of a communication device according to embodiments of the present disclosure.

FIG. 7 is a schematic structural diagram of another communication device according to embodiments of the present disclosure;

FIG. 8 is a schematic structural diagram of a module device according to embodiments of the present disclosure.

### DETAILED DESCRIPTION

The following clearly and completely describes the technical solutions in the embodiments of the present disclosure in combination with the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall belong to the scope of protection of the present disclosure.

The terms used in the following embodiments of the present disclosure is for the purpose of describing particular embodiments only and is not intended to construct a limitation on the present disclosure. As used in the specification of the present disclosure and the appended claims, the singular forms “a”, “an”, and “the” are intended to include the plural forms as well, unless the context clearly indicates otherwise. It may also be understood that, the term “and/or” as used herein refers to and include any or all possible combinations of one or more of listed items.

It may be noted that, the terms “first”, “second”, “third”, and the like in the specification and claims of the present disclosure and the following accompanying drawings are used to distinguish similar objects, and are not necessarily used to describe a particular sequence or order. It may be understood that, the terms thus used may be interchangeable where appropriate, so that the embodiments of the present disclosure described herein, for example, can be implemented in a sequence other than those illustrated or described herein. In addition, the terms “include”, “comprise”, and “have” as well as variations thereof are intended to cover non-exclusive inclusion. For example, a process, method, system, product, or server including a series of steps or units is not limited to the listed steps or units, and instead, it can optionally include other steps or units that are not listed or other steps or units inherent to the process, method, product, or device.

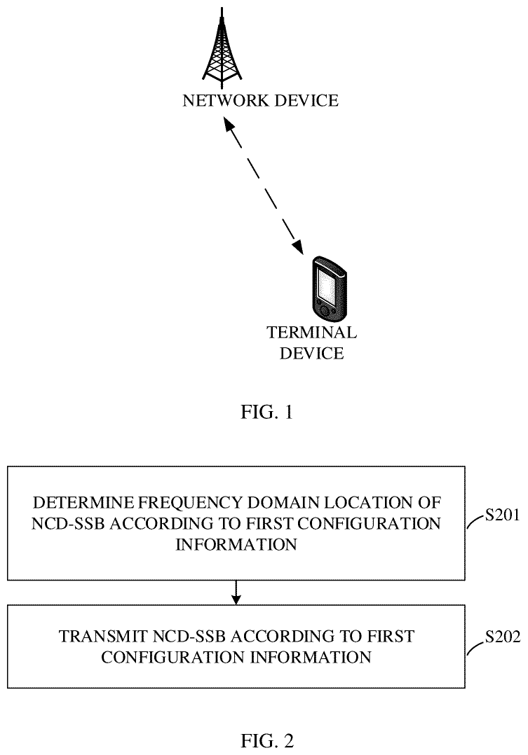

The embodiments of the present disclosure can be applied to a network architecture as illustrated in FIG. 1. The network architecture as illustrated in FIG. 1 is a network architecture of a wireless communication system. The network architecture generally includes a terminal device and a network device. The number and form of each device do not constitute a limitation to the embodiments of the present disclosure.

It may be noted that, the wireless communication system mentioned in the embodiments of the present disclosure includes, but is not limited to, an internet of things (IoT) system, a long term evolution (LTE) system, a 5th-generation mobile communication technology (5G) system, a new radio (NR) system, a 6-generation mobile communication technology (6G) system, and a future mobile communication system.

The terminal device in the embodiments of the present disclosure is a device having a wireless communication function, and may be referred to as a terminal, a terminal user, a user equipment (UE), a mobile station (MS), a mobile terminal (MT), an access terminal device, a vehicle-mounted terminal device, an industrial control terminal device, a UE unit, a UE station, a remote station, a remote terminal device, a mobile device, a terminal device, a wireless communication device, a UE proxy, a UE device, or the like.

The terminal device may be fixed or mobile. It may be noted that, the terminal device can support at least one wireless communication technology, such as LTE, NR, etc. For example, the terminal device may be a mobile phone, a tablet computer (pad), a desktop computer, a laptop computer, an all-in-one computer, a vehicle-mounted terminal, a virtual reality (VR) terminal device, an augmented reality (AR) terminal device, a wireless terminal in industrial control, a wireless terminal in self-driving, a wireless terminal in remote medical surgery, a wireless terminal in a smart grid, a wireless terminal in transportation safety, a wireless terminal in a smart city, a wireless terminal in a smart home, a cellular phone, a cordless phone, a session initiation protocol (SIP) phone, a wireless local loop (WLL) station, a personal digital assistant (PDA), a handheld device with wireless communication functions, a computing device or other processing device connected to a wireless modem, a wearable device, a terminal device in a future mobile communication network, a terminal device in a future evolved public land mobile network (PLMN), etc. In some embodiments of the present disclosure, the terminal device may also be a device with transceiver functions, such as a chip module. The chip module may include a chip and may also include other discrete devices, which is not limited in the present disclosure.

In the embodiments of the present disclosure, the network device is a device that can provide wireless communication functions for the terminal device. The network device may be a radio access network (RAN) device, an access network element, etc. The network device can support at least one wireless communication technology, such as LTE, NR, etc. For example, the network device may include but is not limited to: a generation nodeB (gNB), an evolved node B (eNB), a radio network controller (RNC), a node B (NB), a base station controller (BSC), a base transceiver station (BTS), a home base station (for example, home evolved node B, or home node B (HNB)), a baseband unit (BBU), a transmission and reception point (TRP), a transmitting point (TP), and a mobile switching center, etc., in the 5G. The network device may o be a wireless controller, a centralized unit (CU) and/or a distributed unit (DU) in a cloud radio access network (CRAN) scenario, or the network device may be a relay station, an access point, a vehicle-mounted device, a network device in future mobile communication or a network device in a future evolved PLMN, etc. In some embodiments, the network device may be a device that can provide wireless communication functions for terminal devices, such as a chip module. For example, the chip module may include a chip and may also include other discrete devices. In some embodiments, the network device may further communicate with an internet protocol (IP) network, for example, the internet, a private IP network, or another data network.

The network architecture and service scenarios described in the embodiments of the present disclosure are intended to describe the technical solutions of the embodiments of the present disclosure more clearly, and do not constitute a limitation on the technical solutions provided in the embodiments of the present disclosure. Those skilled in the art can know that, with the evolution of the system architecture and the emergence of new service scenarios, the technical solutions provided in the embodiments of the present disclosure may be also applicable to similar technical problems.

Next, some terms involved in the embodiments of the present disclosure are explained to facilitate comprehension of those skilled in the art.

### Cell Defining (CD)-Synchronization Signal/Physical Broadcast Channel Block (SS/PBCH Block, SSB) and Non-Cell Defining (NCD)-SSB

The CD-SSB is an SSB used by a terminal device to acquire system information (SI) or system information block 1 (SIB1). Generally, SI includes SIB1 and other system information (OSI). For example, a physical broadcast channel (PBCH) carried in the CD-SSB indicates configuration information of a physical downlink control channel (PDCCH) for scheduling SIB1, where the PDCCH is a PDCCH corresponding to a Type1-PDCCH common search space set (SSS). After successfully receiving the PBCH, the terminal device acquires configuration information of the PDCCH for scheduling SIB1, starts to monitor the PDCCH for SIB1, to acquire SIB1 and OSI. In addition to acquiring SI (including initial access, cell selection/reselection, etc.), the CD-SSB can also be used for time-frequency tracking, measurement, beam management, radio link monitoring (RLM), and/or beam failure detection (BFD), etc. Generally, the CD-SSB is blindly detected by the terminal device. Generally, the CD-SSB may be referred to as a cell specific SSB, that is, a cell only has one CD-SSB.

Correspondingly, the NCD-SSB is an SSB incapable of being used by the terminal device to acquire SI. The NCD-SSB may be used for time-frequency tracking, measurement, beam management, RLM, and/or BFD, etc. Generally, the NCD-SSB may be referred to as an on-demand SSB. The NCD-SSB is generally configured by a network device to a terminal device in a connected state through radio resource configuration (RRC) signaling. Generally, the NCD-SSB may be referred to as a UE specific SSB, that is, a cell may have multiple NCD-SSBs, and each terminal device may be configured with a different NCD-SSB. Generally speaking, the NCD-SSB is an SSB which is not used by the terminal device to acquire SI (including SIB1), and a PBCH carried in the NCD-SSB does not need to indicate the configuration information of the PDCCH for SIB1.

### 2. SSS

The SSS may also be referred to as a search space (SS), where the SSS includes a common search space (CSS) and a user-specific search space (USS).

In general, the SSS includes a monitoring occasion of the PDCCH, an SS type for the PDCCH, etc. The SIB1 may be scheduled by the PDCCH in a Type0-PDCCH SSS. The Type0-PDCCH SSS is generally configured by a master information block (MIB) or by radio resource control (RRC) (in the case of handover, etc.).

### 3. Control Resource Set (CORESET)

The CORESET contains a frequency domain resource and a duration of the PDCCH, etc. An SSS is generally bound with a CORESET. A CORESET bound with the Type0-PDCCH SSS is referred to as CORESET#0.

### 4. SSB/CORESET#0 Multiplexing Pattern

The SSB/CORESET#0 multiplexing pattern can also be described as an SSB and CORESET#0 multiplexing pattern including pattern 1, pattern 2, and pattern 3.

In the case of frequency range 1 (FR1), SSB/CORESET#0 multiplexing pattern 1 can be supported.

In the case of FR2, SSB/CORESET#0 multiplexing pattern 1, 2, and 3 can be supported.

For pattern 1, the SSB and CORESET#0 are time division multiplexing (TDM), i. e., the SSB and CORESET#0 use different time domain resources (e. g., slots, symbols, etc.).

Generally, CORSET#0 contains the SSB in the frequency domain. A slot is a time unit, and a symbol is also a time unit. Generally, a slot consists of 14 symbols.

For pattern 2, the SSB and CORESET#0 are frequency division multiplexing (FDM) and TDM, i. e., the SSB and CORESE#0 use different frequency domain resources (e. g., resource blocks, resource block groups, subcarriers, etc.), and CORESET#0 and the SSB associated with CORESET#0 use different time domain resources (e. g., slots, symbols, etc.), for example, CORESET#0 use symbols preceding symbols used by the SSB.

For pattern 3, the SSB and CORESET#0 are FDM, i. e., the SSB and CORESET#0 use different frequency domain resources (e. g., resource blocks, resource block groups, sub-carriers, etc.), and the time domain resources used by CORESET#0 and the SSB associated with CORESET#0 are overlapped, for example, the first 1 or 2 symbols used by the SSB are used by CORESET#0.

It may be noted that, “reduced capability (RedCap) UE specific initial downlink (DL) bandwidth part (BWP)” described in the embodiments of the present disclosure may also be referred to as a first initial DL BWP. The first initial DL BWP involved in the following embodiments of the present disclosure may be understood as an initial DL BWP for the RedCap UE. The first initial DL BWP is also referred to as a separate DL BWP. The first initial DL BWP is typically configured by a higher-layer parameter initialDownlinkBWP-RedCap.

It may be noted that, a second initial DL BWP involved in the embodiments of the present disclosure is understood as an initial DL BWP for ordinary UE (i. e., non-RedCap UE). The second initial DL BWP may also be referred to as a shared initial DL BWP. The second initial DL BWP is generally configured by a higher-layer parameter initialDownlinkBWP.

It may be understood that, when machine type communication (MTC) or internet of things (IoT) is widely applied, SDT is an efficient transmission mode. When the amount of data is relatively small, the terminal device can send and receive data in an inactive state or an idle state without entering a connected state, so that frequent and large number of RRC connection setup and release can be avoided, thereby not only reducing overhead of network signaling, but also reducing power consumption of the terminal device. Specifically, the terminal device may send data (such as message 3 (Msg3)) in a random access channel (RACH) process (or RA for short), which is generally referred to as random access small data transmission (RA-SDT). The terminal device may also send data in configured grant (CG) uplink (UL) transmission or a physical uplink share channel (PUSCH), which is generally referred to as CG-SDT. No matter whether RA-SDT is used or CG-SDT is used, the terminal device can perform subsequent transmission or retransmission or reception.

NR may support RedCap UE. RedCap UE are terminal devices using bandwidths less than 100 MHz. RedCap UE may be used in MTC or IoT. RedCap UE of release 17 may use a bandwidth of 20 MHz in FR1, have 1 or 2 receive antennas and 1 transmit antenna. The peak rate of such RedCap UE is about 150 Mbps in DL and 75 Mbps in UL. In some practical scenarios, for example, low-end industrial sensors, low-resolution cameras, and small wearable devices (such as watches and glasses), the peak rate of about 10 MHz is sufficient for the terminal device. Therefore, the cost for future RedCap UE may be further reduced, for example, the bandwidth for the terminal device is directly reduced to 5 MHz in FR1 or the peak rate of the terminal device is indirectly reduced (using a limited data bandwidth, a limited transmission block size (TBS), etc.).

The RedCap UE can support SDT. Since the bandwidth for the RedCap UE is less than the bandwidth (for example, a bandwidth of 100 MHz under FR1) for ordinary UE, i. e., non-RedCap UE, the network may configure for the RedCap UE a RedCap UE specific initial UL/DL BWPE, and the bandwidth of the initial UL/DL BWP is less than or equal to the maximum bandwidth (for example, 20 MHz under FR1) for the RedCap UE. The RedCap UE specific initial UL/DL BWP is also referred to as a first initial UL/DL BWP or separate UL/DL BWP.

SDT may be operated in the initial UL/DL BWP. For SDT, a physical uplink signal/physical uplink channel used may be configured in the initial UL BWP, and a physical downlink signal/physical downlink channel used may be configured in the initial DL BWP. For example, for RA-SDT, a physical uplink signal/physical uplink channel used in RA may be configured in the initial UL BWP, and a physical downlink signal/physical downlink channel used in RA may be configured in the initial DL BWP. For example, for CG-SDT, a CG-PUSCH may be configured in the initial UL BWP, and a PDCCH used for hybrid automatic retransmission request (HARQ) feedback may be configured in the initial DL BWP.

As described above, when the RedCap UE performs SDT, the RedCap UE can use the first initial DL/UL BWP. In a scenario where the first initial DL BWP does not contain a CD-SSB and CORESET#0, the RedCap UE needs to process an SSB, receive paging, etc., in a second initial DL BWP that contains a CD-SSB. Generally, a CD-SSB is an SSB used by the UE to acquire SI including an SIB1. Processing an SSB includes SSB-based time-frequency synchronization (or time-frequency tracking), SSB-based measurement and timing alignment (TA) validation, etc. Receiving paging includes receiving a paging PDCCH (a PDCCH configured by a paging SS) and receiving a physical downlink shared channel (PDSCH) scheduled by the paging PDCCH (which may be referred to as a paging PDSCH).

Based on this, the embodiments of the present disclosure provide a communication method, which can realize that the RedCap UE can use SDT in the RedCap UE specific initial DL BWP.

The communication method, device, chip, and module device provided in the embodiments of the present disclosure are further described in detail in the following.

Referring to FIG. 2, FIG. 2 is a schematic flow chart of a communication method according to embodiments of the present disclosure. The method as illustrated in FIG. 2 may be executed by a terminal device or a network device. Alternatively, the method as illustrated in FIG. 2 may be executed by a chip in the terminal device or a chip in the network device. The terminal device may be understood as a RedCap UE. For ease of illustration, the method provided by the present disclosure is exemplarily described by taking that the method is executed by the terminal device or the network device as an example. As illustrated in FIG. 2, the method includes S201-S202 as follows.
S201, a frequency domain location of an NCD-SSB is determined according to first configuration information.

Specifically, the network device can transmit first configuration information to the terminal device, and accordingly, the terminal device receives the first configuration information from the network device, where the first configuration information is used for configuring the frequency domain location of the NCD-SSB. That is to say, in the case where the method is executed by the network device, the network device can determine the frequency domain location of the NCD-SSB according to the first configuration information. In the case where the method is executed by the terminal device, the terminal device can determine the frequency domain location of the NCD-SSB according to the first configuration information received from the network device.

The frequency domain location of the NCD-SSB may be located in a first initial DL BWP, and thus the RedCap UE can use the NCD-SSB in the first initial DL BWP, thereby reducing the frequency of BWP switching. That is to say, the RedCap UE receives the NCD-SSB from the network device according to the first configuration information, and the first initial DL BWP is used for SDT. It may be noted that, in the present disclosure, “within the BWP” or “in the BWP” may be understood as using a resource(s) within (in) the BWP or using a resource(s) on the BWP. “Within the BWP” or “in the BWP” may also be understood as “on the BWP”. “Within the BWP” or “in the BWP” includes “in the BWP” or “on the BWP”, or “with the BWP”, which are not limited herein.

The first configuration information may be carried in SI, that is to say, the first configuration information may be transmitted via SI. In this way, the RedCap UE can acquire the first configuration information in the case where the RedCap UE initially accesses the network, and thus the RedCap UE can use the NCD-SSB as soon as possible.

Optionally, the first configuration information may also be carried in dedicated RRC signaling. That is to say, the first configuration information can be transmitted via the dedicated RRC signaling. In this way, the RedCap UE can only acquire the first configuration information after completing initial access, that is, the UE can use the NCD-SSB only in a connected state or an inactive state. Compared with using a CD-SSB, the network overhead can be reduced, and this is because the CD-SSB is always on, while the NCD-SSB in the present disclosure is transmitted on demand or UE specific. In general, the NCD-SSB is an SSB which is not used by the RedCap UE to acquire SI (including SIB1), and a PBCH carried in the NCD-SSB does not need to indicate configuration information of a PDCCH for SIB1.

The dedicated RRC signaling is also referred to as UE-specific RRC signaling, etc. It can be understood that, the dedicated RRC signaling may specifically include RRC reconfiguration signaling, RRC release signaling, etc., which is not limited herein. In this way, in the case where the dedicated RRC signaling is the RRC reconfiguration signaling, the terminal device can use the NCD-SSB in a connected state, and the configuration can be retained in an inactive state. In the case where the dedicated RRC signaling is RRC release signaling, the terminal device can only use the NCD-SSB in the inactive state. In general, for both modes, in the inactive state, the terminal device can use the NCD-SSB, that is, the terminal device can use the NCD-SSB for SDT.

Optionally, the first configuration information may be carried in a dedicated DL BWP configuration (indicated by a parameter BWP-DownlinkDedicated), where the parameter BWP-DownlinkDedicated is contained in dedicated RRC signaling. That is to say, the first configuration information can be transmitted via the dedicated RRC signaling, and the RedCap UE can only acquire the first configuration information after completing initial access, that is, the RedCap UE can only use the NCD-SSB in the connected state or inactive state, which can reduce network overhead. Using the parameter BWP-DownlinkDedicated can avoid excessive signaling, thereby reducing signaling overhead.
S202, the NCD-SSB is transmitted according to the first configuration information.

It may be noted that, the transmission in the present disclosure includes transmission and/or reception.

Specifically, the network device can transmit the NCD-SSB according to the first configuration information, and accordingly, the RedCap UE can receive the NCD-SSB according to the first configuration information.

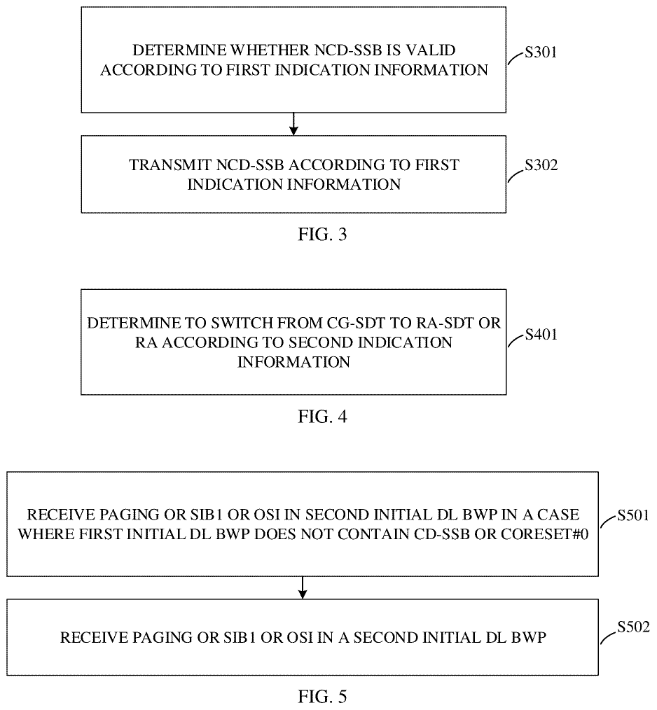

It may be noted that, the network device generally periodically transmits the NCD-SSB, which may result in a large overhead for NCD-SSB transmission. Therefore, to reduce the overhead for NCD-SSB transmission, the following method as illustrated in FIG. 3 is proposed.

Referring to FIG. 3, FIG. 3 is a schematic flow chart of another communication method according to embodiments of the present disclosure. The method as illustrated in FIG. 3 may be executed by a terminal device or a network device. Alternatively, the method as illustrated in FIG. 3 may be executed by a chip in the terminal device or a chip in the network device. The terminal device may be understood as a RedCap UE. For ease of illustration, the method provided by the present disclosure is exemplarily described by taking that the method is executed by the terminal device or the network device as an example. As illustrated in FIG. 3, the method includes S301-S302 as follows:
S301, whether an NCD-SSB is valid is determined according to first indication information.

Specifically, the network device can transmit the first indication information to the terminal device, and correspondingly, the terminal device can receive the first indication information from the network device. The first indication information indicates whether the NCD-SSB is valid, that is to say, in the case where the method is executed by the network device, the network device indicates whether the NCD-SSB is valid via the first indication information. In the case where the method is executed by the terminal device, the terminal device can determine whether the NCD-SSB is valid according to the first indication information received from the network device. In the case where the method is executed by the network device, the network device indicates to the terminal device whether the NCD-SSB is valid via the first indication information. In the case where the NCD-SSB is valid, the network device will transmit the NCD-SSB; and in the case where the NCD-SSB is invalid, the network device will not transmit the NCD-SSB.

That is to say, whether the NCD-SSB is valid may be dynamically indicated to the terminal device by the network device, so as to effectively control the overhead for the NCD-SSB. For example, in the case where the network device configures (generally periodically) the NCD-SSB for a terminal device in a connected state, the network device can share the NCD-SSB transmitted by the network device with a terminal device in an inactive state (using SDT in a first initial DL BWP), However, in the case where the terminal device in the connected state is released, the network device may not transmit the NCD-SSB, and notify the terminal device in the inactivated state that the NCD-SSB is invalid, so as to prevent the terminal device in the inactivated state from processing the NCD-SSB. In this way, the case that the terminal device in the inactive state can use the NCD-SSB can be realized, and thus the frequency of BWP switching can be reduced, and additionally, the overhead of network resource can be effectively controlled. It may be noted that, in the case where the network device, when not transmitting the NCD-SSB, notifies the terminal device in the inactivated state that the NCD-SSB is invalid, the case that the terminal device performs measurement can be avoided.

Optionally, the frequency domain location of the NCD-SSB is located in a first initial DL BWP.

It can be understood that, the first indication information may be carried in DCI.

Optionally, the DCI is carried in a PDCCH associated with SDT, where the PDCCH associated with SDT may be configured by an SS associated with SDT. In this way, a PDCCH configuration designed for SDT can be reused, and the PDCCH is configured by an SS or SSS associated with SDT, such as sdt-CG-SearchSpace, where the sdt-CG-SearchSpace belongs to a CSS and can be used for CG-SDT. Also for example, the PDCCH is configured by sdt-SearchSpace, where the sdt-SearchSpace belongs to a USS and can be used for CG-SDT and RA-SDT.

Optionally, the first indication information may be carried in a media access control-control entity (MAC-CE). The MAC CE is carried in a PDSCH, the PDSCH is scheduled by a PDCCH associated with SDT, and the PDCCH is configured by an SS associated with SDT. As such, the PDCCH configuration designed for SDT and PDSCH configuration scheduled by the PDCCH may be reused.

It may be understood that, the network device can dynamically transmit the first indication information via the DCI or MAC-CE. Generally, DCI signaling may result in relatively short delay but relatively low reliability, while MAC-CE signaling may result in relatively long delay but relatively high reliability.

It may be noted that, in the case where the first indication information indicates that the NCD-SSB is valid, the NCD-SSB is valid in a first period of time. That is to say, the first indication information may indicate that the NCD-SSB is valid in a period of time. In this way, by means of a period of time (or a time window), the NCD-SSB is valid only in a short period, thereby reducing overhead of network resource, that is, the overhead of resources for transmitting the NCD-SSB.

A duration of the first period of time may be a preset duration, or the duration of the first period of time may be configured via high-layer signaling. In this way, by means of a preset or configured period of time (or time window), the information amount of the first indication information can be reduced, and thus the signaling overhead of the first indication information can be reduced.

It may be understood that, a starting time of the first period of time may be a starting time or an end time of a slot where the first indication information is received, or the starting time of the first period of time may be a starting time or an end time of a cycle that contains the slot where the first indication information is received. In this way, by defining the starting time of the period of time as the starting time of the slot where the first indication information is received by the terminal device, the terminal device can use the NCD-SSB as timely as possible. By defining the starting time of the period of time as the starting time of the cycle that contains the slot where the first indication information is received by terminal devices, all the terminal devices instructed can adopt the NCD-SSB within the same cycle, thereby achieving consistency, and thus effectively controlling the overhead of network resources, i. e., the overhead of resources for transmitting the NCD-SSB.

It may be understood that, the starting time of the first period of time may be a certain symbol of the slot where the first indication information is received, or the starting time of the first period of time may be a certain symbol of the cycle that contains the slot where the first indication information is received. As such, flexibility may be increased.

It can be understood that, the cycle may be a preset cycle, or the cycle may be configured via high-layer signaling. In this way, by presetting a reasonable period or configuring a reasonable period by the network device, the overhead of network resources can be effectively controlled according to actual scenario requirements. For example, the cycle may be a paging cycle, such that the configuration of the paging cycle may be reused.
S302, the NCD-SSB is transmitted according to the first indication information.

Specifically, the network device can transmit the NCD-SSB only when the NCD-SSB is valid, and accordingly, the terminal device can receive the NCD-SSB only when it is determined that the NCD-SSB is valid, so that the overhead of network resources can be effectively controlled.

In the embodiments of the present disclosure, whether the NCD-SSB is valid is indicated by means of first indication information, and the network device can transmit the NCD-SSB only when it is indicated that the NCD-SSB is valid, accordingly, the terminal device can receive the NCD-SSB only when it is determined that the NCD-SSB is valid, so that the overhead of network resources can be effectively controlled.

Another scheme that a RedCap UE can use SDT in a RedCap UE specific initial DL BWP is described below.

Referring to FIG. 4, FIG. 4 is a schematic flow chart of another communication method according to embodiments of the present disclosure. The method as illustrated in FIG. 4 may be executed by a terminal device. Alternatively, the method as illustrated in FIG. 4 may be executed by a chip in the terminal device, where the terminal device may be understood as a RedCap UE. For ease of illustration, the method provided by the present disclosure is described exemplarily by taking that the method is executed by the terminal device as an example. As illustrated in FIG. 4, the method includes S401-S402 as follows.
S401, it is determined to switch from CSG-SDT to RA-SDT or RA according to second indication information.

Specifically, a network device may transmit the second indication information to the terminal device, and correspondingly, the terminal device may receive the second indication information from the network device. The second indication information is used to instruct the terminal device to switch from CG-SDT to RA-SDT or RA. In this way, the network device does not need to rely on paging to enable the terminal device to initiate RA (some steps of RA-SDT also belong to RA), and the terminal device also does not need to switch to a second initial DL BWP to receive paging, thereby reducing the frequency of BWP switching. The expression “the terminal device switches from CG-SDT to RA” in the embodiments of the present disclosure can also be understood as “the terminal device falls back from CG-SDT to RA”, i. e., the second indication information is used to instruct the terminal device to fall back from CG-SDT to RA.

It can be understood that, the second indication information may be carried in DCI. The DCI is carried in a PDCCH associated with SDT, the PDCCH associated with SDT may be configured by an SS associated with SDT, and “the PDCCH associated with SDT” is a PDCCH of a certain type. In this way, a PDCCH configuration designed for SDT can be reused, and the PDCCH is configured by an SS or SSS associated with SDT, such as sdt-CG-SearchSpace, where the sdt-CG-SearchSpace belongs to a CSS and can be used for CG-SDT. Also for example, the PDCCH is configured by may be configured by sdt-SearchSpace, where the sdt-SearchSpace belongs to a USS and can be used for CG-SDT and RA-SDT.

Optionally, the second indication information may be carried in a MAC-CE. The MAC CE is carried in a PDSCH, the PDSCH is scheduled by a PDCCH associated with SDT, and the PDCCH is configured by an SS associated with SDT. As such, the PDCCH configuration designed for SDT and a PDSCH configuration scheduled by the PDCCH may be reused.

It may be understood that, the network device can dynamically transmit the second indication information via the DCI or MAC-CE. Generally, DCI signaling may result in relatively short delay but relatively low reliability, while MAC-CE signaling may result in relatively long delay but relatively high reliability.

In the embodiments of the present disclosure, the network device can transmit signaling similar to paging in a physical downlink signal/physical downlink channel associated with SDT (such as the PDCCH associated with SDT), so that the terminal device can receive paging in a first initial DL BWP as far as possible.

It may be noted that, in the case where the first initial DL BWP does not contain a CD-SSB or CORESET#0, how the RedCap UE can receive paging in an initial DL BWP containing CORESET#0 and/or a CD-SSB is a problem.

It may be noted that, in the scenario where the first initial DL BWP does not contain a CD-SSB, the RedCap UE needs to process an SSB in a second initial DL BWP that contains a CD-SSB, so that the RedCap UE needs to frequently switch between the second initial DL BWP and the first initial DL BWP, which may result in increased power consumption of the RedCap UE since additional radio frequency operations are required for each switching. Therefore, how to reduce the frequency of that the RedCap UE switches between the second initial DL BWP and the first initial DL BWP is one of the problems to be solved urgently.

Referring to FIG. 5, FIG. 5 is a schematic flow chart of another communication method according to embodiments of the present disclosure. The method as illustrated in FIG. 5 may be executed by a terminal device. Alternatively, the method as illustrated in FIG. 5 may be executed by a chip in a terminal device, where the terminal device may be understood as a RedCap UE. For ease of illustration, the method provided by the present disclosure is described exemplarily by taking that the method is executed by the terminal device as an example. As illustrated in FIG. 5, the method includes S501-S502 as follows.
S501, in the case where a first initial DL BWP does not contain a CD-SSB or CORESET#0, paging or SIB1 or OSI is received in a second initial DL BWP. It may be noted that, “receiving paging or SIB1 or OSI” is equivalent to “monitoring a PDCCH for paging or SIB1 or OSI” or “monitoring an SS for paging or SIB1 or OSI”. It may be noted that, “not containing a CD-SSB or CORESET#0” may include one or more of the following cases: not containing both a CD-SSB and CORESET#0, not containing a CD-SSB, and not containing CORESET#0.

A frequency location and bandwidth of the second initial DL BWP is the same as a frequency location and bandwidth of the CORESET#0, or the frequency location and bandwidth of the second initial DL BWP is the same as a frequency location and bandwidth of a frequency span formed by the CD-SSB and CORESET#0. It may be noted that, “frequency location and bandwidth” may indicate “location of a contiguous frequency resource” or “starting location and size of a contiguous frequency resource”. In some cases, “bandwidth” may mean “frequency location and bandwidth”, and “frequency location and bandwidth” may be replaced by “bandwidth” in this case. It may be noted that, generally, a frequency location and bandwidth of a BWP may be configured by a parameter locationAndBandwidth, and the frequency location and bandwidth of the second initial DL BWP may also be configured by a parameter locationAndBandwidth.

The frequency span formed by the CD-SSB and CORESET#0 is a set of contiguous resource blocks (RBs) or physical resource blocks (PRBs) containing the CD-SSB and CORESET#0, or the frequency span formed by the CD-SSB and CORESET#0 is a set of a minimum number of contiguous RBs or PRBs containing the CD-SSB and CORESET#0.

In this way, by defining the frequency location and bandwidth of the second initial DL BWP, the RedCap UE can be limited to receive paging or SIB1 or OSI only in the initial DL BWP containing the CD-SSB and CORESET#0, and thus the network device can control the non-RedCap UE and RedCap UE to receive paging or SIB1 or OSI in the same PDCCH and PDSCH time-frequency resource. It may be noted that, in the case where the frequency location and bandwidth of the second initial DL BWP is the same as the frequency location and bandwidth of the CORESET#0, for receiving paging or SIB1 or OSI, no matter whether the terminal device uses the first initial DL BWP or the CORESET#0, the frequency domain resources of the PDCCH and the PDSCH are the same. It may be noted that, in the case where the frequency location and bandwidth of the second initial DL BWP is the same as the frequency location and bandwidth of the frequency span formed by the CD-SSB and CORESET#0, for receiving paging or SIB1 or OSI, no matter whether the terminal device uses the first initial DL BWP or the CORESET#0, the frequency domain resources of the PDCCH and the PDSCH are the same.

It can be understood that, “the frequency location and bandwidth of the second initial DL BWP is the same as the frequency location and bandwidth of the CORESET #0” applies to the case where the CORESE #0 contains the CD-SSB, and in this case, the frequency location and bandwidth of the second initial DL BWP may contain the CD-SSB; “the frequency location and bandwidth of the second initial DL BWP is the same as the frequency location and bandwidth of the frequency span formed by the CD-SSB and CORESET#0” applies to the case where the CORESET#0 does not contain the CD-SSB, and in this case, the frequency location and bandwidth of the second initial DL BWP can contain both the CORESET#0 and the CD-SSB On the other hand, in the case where the first initial DL BWP does not contain the CD-SSB or the CORESET#0, the configuration information of the CORESET#0 in the first initial DL BWP is absent. In this way, it can be ensured that there is only one CORESET#0 in a cell, in this case, the terminal device still uses the configuration information of the CORESET#0 in the second initial DL BWP as the configuration information of the CORESET#0.

On the other hand, in the case where the first initial DL BWP does not contain the CD-SSB or the CORESET#0, a common CORESET within the first initial DL BWP may not be contained within the CORESET#0. In this case, the CORESET#0 is not contained in the first initial DL BWP or is not completely contained in the first initial DL BWP, while the common CORESET is contained in the first initial DL BWP or is completely contained in the first initial DL BWP, and therefore the common CORESET may not be contained in the CORESET#0. It may be noted that, the common CORESET is not used for the PDCCH associated with paging, SIB1, or OSI, and is generally used for the PDCCH associated with RA.

It may be noted that, in the case of FR1 or SSB/CORSET#0 multiplexing pattern 1, the frequency location and bandwidth of the second initial DL BWP is the same as the frequency location and bandwidth of the CORESET#0. As such, the RedCap UE can determine the frequency location and bandwidth of the second initial DL BWP according to a frequency range in this case or according to SSB/CORSET#0 multiplexing pattern. In the case of FR1 or SSB/CORSET#0 multiplexing mode 1, CORESET#0 contains the CD-SSB.

It may be noted that, in the case of FR2 or SSB/CORSET#0 multiplexing pattern 2 or mode 3, the frequency location and bandwidth of the second initial DL BWP is the same as the frequency location and bandwidth of the frequency span formed by the CD-SSB and the CORESET#0. As such, the RedCap UE can determine the frequency location and bandwidth of the second initial DL BWP according to the frequency range or according to the SSB/CORSET#0 multiplexing pattern. In the case of FR2 or SSB/CORSET#0 multiplexing pattern 2 or mode 3, CORESET#0 does not contain the CD-SSB.
S502, paging or SIB1 or OSI is received in the second initial DL BWP.

It can be understood that, for the network device, the network device can transmit paging or SIB1 or OSI in the second initial DL BWP, and correspondingly, the terminal device can receive paging or SIB1 or OSI in the second initial DL BWP.

The embodiments of the present disclosure propose a solution of how the RedCap UE can receive paging or SIB1 or OSI in an initial DL BWP containing the CORESET#0 and/or CD-SSB in the case where the first initial DL BWP does not contain the CD-SSB or CORESET#0, which is beneficial to improving the reliability of communication.

It may be noted that, the steps in FIG. 2, FIG. 3, FIG. 4, or FIG. 5 may be used as an embodiment alone, or may be used as an optional step in combination with one or more steps in other embodiments, which is not limited herein. For example, the embodiments illustrated in FIG. 2 and FIG. 3 may be combined to serve as a new embodiment.

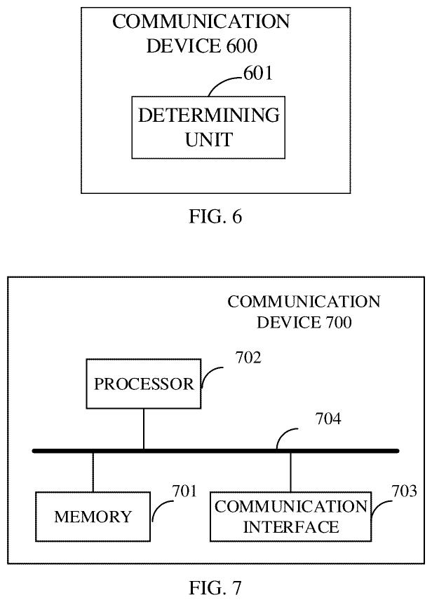

Referring to FIG. 6, FIG. 6 is a schematic structural diagram of a communication device according to embodiments of the present disclosure. The communication device may be a terminal device or a device having a terminal device function (for example, a chip), or the communication device may be a network device or a device having a network device function (for example, a chip). The communication device may execute the steps performed by the terminal device or the network device in the foregoing method embodiments. Specifically, as illustrated in FIG. 6, the communication device 600 includes a determining unit 601.

In one embodiment, the determining unit 601 is configured to determine a frequency domain location of an NCD-SSB according to first configuration information.

Optionally, the frequency domain location of the NCD-SSB is located in a first initial DL BWP.

Optionally, the first configuration information is carried in SI, or the first configuration information is carried in a dedicated RRC signaling.

Optionally, the dedicated RRC signaling includes one or more of the following types of signaling: RRC reconfiguration signaling and RRC release signaling.

In yet another embodiment, the determining unit 601 is configured to determine whether an NCD-SSB is valid according to first indication information.

Optionally, the first indication information is carried in DCI.

Optionally, the DCI is carried in a PDCCH associated with SDT, where the PDCCH is configured by an SS associated with SDT.

Optionally, the first indication information is carried in a MAC-CE.

Optionally, the MAC CE is carried in a PDSCH, the PDSCH is scheduled by a PDCCH associated with SDT, and the PDCCH is configured by an SS associated with SDT.

Optionally, the case that the first indication information indicates that the NCD-SSB is valid is specifically that the first indication information indicates that the NCD-SSB is valid in a first period of time.

Optionally, a duration of the first period of time is a preset duration, or the duration of the first period of time is configured by high-layer signaling.

Optionally, the starting time of the first period of time is the starting time of a slot where the first indication information is received, or the starting time of the first period of time is the starting time of a cycle that contains the slot where the first indication information is received.

Optionally, the cycle is a preset cycle, or the cycle is configured by high-layer signaling.

Optionally, the cycle includes a paging cycle.

Optionally, a frequency domain location of the NCD-SSB is located in a first initial DL BWP.

In yet another embodiment, the determining unit 601 is configured to determine to switch from configured grant (CG)-SDT to random access (RA) according to second indication information.

Optionally, the second indication information is carried in DCI.

Optionally, the DCI is carried in a PDCCH associated with SDT, where the PDCCH is configured by an SS associated with SDT.

Optionally, the second indication information is carried in a MAC-CE.

Optionally, the MAC-CE is carried in a PDSCH, the PDSCH is scheduled by a PDCCH associated with SDT, and the PDCCH is configured by an SS associated with SDT.

In yet another embodiment, the determining unit 601 is configured to receive paging or SIB1 or OSI within a second initial DL BWP in a case where the first initial DL BWP does not contain a CD-SSB or CORESENT#0, where the second initial DL BWP is configured by a parameter initialDownlinkBWP, a frequency location and bandwidth of the second initial DL BWP is the same as a frequency location and bandwidth of the CORESENT#0, or the frequency location and bandwidth of the second initial DL BWP is the same as a frequency location and bandwidth of a frequency span formed by the CD-SSB and the CORESENT#0.

Optionally, in the case of FR1 or SSB/CORSET#0 multiplexing pattern 1, the frequency location and bandwidth of the second initial DL BWP is the same as the frequency location and bandwidth of the CORESET#0.

Optionally, in the case of FR2 or SSB/CORSET#0 multiplexing pattern 2 or SSB/CORSET#0 multiplexing pattern 3, the frequency location and bandwidth of the second initial DL BWP is the same as the frequency location and bandwidth of the frequency span formed by the CD-SSB and CORESENT#0.

Embodiments of the present disclosure further provide a chip. The chip can execute related steps performed by the terminal device or network device in the foregoing method embodiments. The chip includes a processor and a communication interface, where the processor is configured to enable the chip to execute the following operations.

In an embodiment, a frequency domain location of an NCD-SSB is determined according to first configuration information.

Optionally, the frequency domain location of the NCD-SSB is located in a first initial DL BWP.

Optionally, the first configuration information is carried in SI, or the first configuration information is carried in dedicated RRC signaling.

Optionally, the dedicated RRC signaling includes one or more of the following types of signaling: RRC reconfiguration signaling and RRC release signaling.

In yet another embodiment, whether an NCD-SSB is valid is determined according to first indication information.

Optionally, the first indication information is carried in DCI.

Optionally, the DCI is carried in a PDCCH associated with SDT, where the PDCCH is configured by an SS associated with SDT.

Optionally, the first indication information is carried in a MAC-CE.

Optionally, the MAC CE is carried in a PDSCH, the PDSCH is scheduled by a PDCCH associated with SDT, and the PDCCH is configured by an SS associated with SDT.

Optionally, the case that the first indication information indicates that the NCD-SSB is valid is specifically that the first indication information indicates that the NCD-SSB is valid in a first period of time.

Optionally, a duration of the first period of time is a preset duration, or the duration of the first period of time is configured via high-layer signaling.

Optionally, the starting time of the first period of time is the starting time of a slot where the first indication information is received, or the starting time of the first period of time is the starting time of a cycle that contains the slot where the first indication information is received.

Optionally, the cycle is a preset cycle, or the cycle is configured via high-layer signaling.

Optionally, the cycle includes a paging cycle.

Optionally, a frequency domain location of the NCD-SSB is located in the first initial DL BWP.

In yet another embodiment, it is determined to switch from CG-SDT to RA according to second indication information.

Optionally, the second indication information is carried in DCI.

Optionally, the DCI is carried in a PDCCH associated with SDT, where the PDCCH is configured by an SS associated with SDT.

Optionally, the second indication information is carried in a MAC-CE.

Optionally, the MAC CE is carried in a PDSCH, the PDSCH is scheduled by a PDCCH associated with SDT, and the PDCCH is configured by an SS associated with SDT.

In yet another embodiment, paging or SIB1 or OSI is received within a second initial DL BWP in a case where a first initial DL BWP does not contain a CD-SSB or CORESENT#0, where the second initial DL BWP is configured by a parameter intialDownlinkBWP, a frequency location and bandwidth of the second initial DL BWP is the same as a frequency location and bandwidth of the CORESENT#0, or the frequency location and bandwidth of the second initial DL BWP is the same as a frequency location and bandwidth of a frequency span formed by the CD-SSB and CORESENT#0.

Optionally, in the case of FR1 or SSB/CORSET#0 multiplexing pattern 1, the frequency location and bandwidth of the second initial DL BWP is the same as the frequency location and bandwidth of the CORESET#0.

Optionally, in the case of FR2 or SSB/CORSET#0 multiplexing pattern 2 or SSB/CORSET#0 multiplexing pattern 3, the frequency location and bandwidth of the second initial DL BWP is the same as the frequency location and bandwidth of the frequency span formed by the CD-SSB and the CORESENT#0.

Referring to FIG. 7, FIG. 7 is a schematic structural diagram of still another communication device according to embodiments of the present disclosure. The communication device may be a terminal device or a network device, and the communication device 700 may include a memory 701 and a processor 702. Optionally, a communication interface 703 is further included. The memory 701, the processor 702, and the communication interface 703 are connected through one or more communication buses 704. The communication interface 703 is controlled by the processor 702 to receive and transmit information.

The memory 701 may include a read-only memory and/or a random access memory, and can provide instructions and data for the processor 702. Part of the memory 701 may also include a non-volatile random access memory.

The communication interface 703 is configured to receive or transmit data.

The processor 702 may be a central processing unit (CPU), and may be another general processor, a digital signal processor (DSP), an application specific integrated circuit (ASIC), a field-programmable gate array (FPGA), or another programmable logic device, a discrete gate, a transistor logic device, a discrete hardware component, or the like. The general-purpose processor may be a microprocessor, and optionally, the processor 702 may also be any conventional processor.

The memory 701 is configured to store program instructions.

The processor 702 is configured to invoke program instructions stored in the memory 701.

The processor 702 is configured to invoke program instructions stored in the memory 701, so that the communication device 700 can execute the method executed by the terminal device or the network device in the foregoing method embodiments.

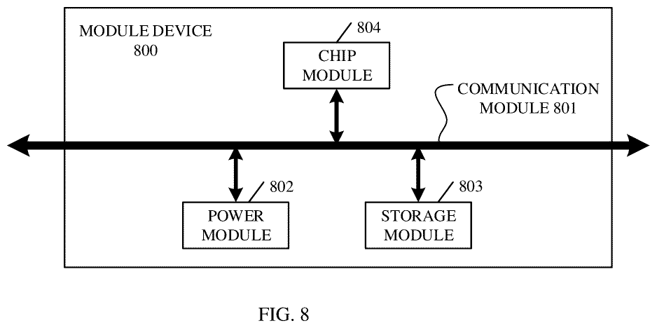

Referring to FIG. 8, FIG. 8 is a schematic structural diagram of a module device according to embodiments of the present disclosure. The module device 800 may execute steps performed by the terminal device or the network device in the foregoing method embodiments. The module device 800 includes a communication module 801, a power supply module 802, a storage module 803, and a chip module 804.

The power supply module 802 is configured to power the module device. The storage module 803 is configured to store data and instructions. The communication module 801 is configured to perform internal communication of a module device, or used for communication between the module device and an external device. The chip module 804 is configured to execute the methods executed by the terminal device or the network device in the foregoing method embodiments.

It may be noted that, for content not mentioned in the embodiments corresponding to FIGS. 6-8 and specific implementations of each step, reference may be made to the embodiments illustrated in FIGS. 2-5 and the foregoing content, and details are not described herein again.

Embodiments of the present disclosure further provide a computer-readable storage medium. The computer-readable storage medium stores instructions. When the instructions are run on a processor, a method of the method embodiments is implemented.

Embodiments of the present disclosure further provide a computer program product. When the computer program product is run on a computer, a method of the method embodiments is implemented.

Various modules/units included in each device or product described in the foregoing embodiments may be software module/units, hardware module/units, partly software modules/units, or partly hardware modules/units. For example, various modules/units included in various devices and products applied to or integrated into a chip may all be implemented by means of hardware, such as a circuit, or at least some of the modules/units may be implemented by means of a software program run on an integrated processor inside the chip, and some (if any) of the remaining modules/units may be implemented by means of hardware, such as a circuit. With regard to various devices and products applied to or integrated in a chip module, various modules/units contained therein can all be realized by means of hardware, such as a circuit. Different modules/units may be located in the same component (e. g., chip, circuit module, etc.) of a chip module or in different components of a chip module. Alternatively, at least some of the modules/units may be implemented using a software program run on a processor integrated within the chip module, the remaining (if any) of the modules/units may be implemented by hardware such as circuits. With regard to various devices and products applied to or integrated into a terminal device, modules/units contained therein can all be realized by means of hardware, such as a circuit. Different modules/units may be located in the same component (e. g., chip, circuit module, etc.) or different components within the terminal device. Alternatively, at least some of the modules/units may be implemented by using a software program run on a processor integrated inside the terminal device, and the remaining (if any) of the modules/units may be implemented by hardware such as a circuit.

It may be noted that, for brevity of illustration, the foregoing method embodiments are described as a combination of a series of actions. However, persons skilled in the art should understand that the present disclosure is not limited by the described action sequence, because according to the present disclosure, some operations may be performed in another sequence or simultaneously. Secondly, those skilled in the art should also know that the embodiments described in the specification are all preferred embodiments, and the involved actions and modules are not necessarily required in the present disclosure.

Illustrations of the embodiments provided in the present disclosure may be referred to each other, and the illustration of each embodiment has its own emphasis. For the parts not described in detail in one embodiment, reference may be made to related illustrations in other embodiments. For convenience and brevity of illustration, for example, for functions and operations performed by the apparatuses and devices provided in the embodiments of the present disclosure, reference may be made to the relevant illustration of the method embodiments of the present disclosure, and reference may be made to each other between the method embodiments and the apparatus embodiments, the method embodiments may be combined, the apparatus embodiments may be combined, or the method embodiments and the apparatus embodiments may be referred to each other.

Finally, it may be noted that, the foregoing embodiments are merely intended for describing the technical solutions of the present disclosure rather than limiting the present disclosure. Although the present disclosure is described in detail in combination with the foregoing embodiments, persons of ordinary skill in the art should understand that they may still make modifications to the technical solutions described in the foregoing embodiments, or make equivalent replacements to some or all technical features thereof. These modifications or replacements do not make the essence of the corresponding technical solutions depart from the scope of the technical solutions of the embodiments of the present disclosure.

1. A communication method, comprising:
determining a frequency domain location of a non-cell defining (NCD)-synchronization signal/physical broadcast channel block (SSB) according to first configuration information.

2. The method according to claim 1, wherein the frequency domain location of the NCD-SSB is located in a first initial downlink (DL) bandwidth part (BWP).

3. The method according to claim 1, wherein the first configuration information is carried in system information (SI), or the first configuration information is carried in dedicated radio resource control (RRC) signaling.

4. The method according to claim 3, wherein the dedicated RRC signaling comprises one or more of the following types of signaling:
RRC reconfiguration signaling and RRC release signaling.

5. A communication method, comprising:
determining whether a non-cell defining (NCD)-synchronization signal/physical broadcast channel block (SSB) is valid according to first indication information.

6. The method according to claim 5, wherein the first indication information is carried in downlink control information (DCI).

7. The method according to claim 6, wherein the DCI is carried in a physical downlink control channel (PDCCH) associated with small data transmission (SDT), wherein the PDCCH is configured by a search space (SS) associated with SDT.

8. The method according to claim 5, wherein the first indication information is carried in a medium access control-control entity (MAC-CE).

9. The method according to claim 8, wherein the MAC CE is carried in a physical downlink shared channel (PDSCH), the PDSCH is scheduled by a PDCCH associated with SDT, and the PDCCH is configured by an SS associated with SDT.

10. The method according to claim 5, wherein the case that the first indication information indicates that the NCD-SSB is valid is that the first indication information indicates that the NCD-SSB is valid within a first period of time.

11. The method according to claim 10, wherein a duration of the first period of time is a preset duration, or the duration of the first period of time is configured via high-layer signaling.

12. The method according to claim 10, wherein a starting time of the first period of time is a starting time of a slot where the first indication information is received, or the starting time of the first period of time is a starting time of a cycle that contains the slot where the first indication information is received.

13. The method according to claim 12, wherein the cycle is a preset cycle, or the cycle is configured via high-layer signaling.

14. The method according to claim 12, wherein the cycle comprises a paging cycle.

15. The method according to claim wherein a frequency domain location of the NCD-SSB is located in a first initial downlink (DL) bandwidth part (BWP).

16-20. (canceled)

21. A communication method, comprising:
receiving paging or system information block 1 (SIB1) or other system information (OSI) in a second initial downlink (DL) bandwidth part (BWP) in a case where a first initial DL BWP does not contain a cell defining (CD)-synchronization signal/physical broadcast channel block (SSB) or control resource set zero (CORESENT#0), wherein a frequency location and bandwidth of the second initial DL BWP is the same as a frequency location and bandwidth of the CORESENT#0, or the frequency location and bandwidth of the second initial DL BWP is the same as a frequency location and bandwidth of a frequency span formed by the CD-SSB and the CORESENT#0.

22. The method according to claim 21, wherein in the case of frequency range 1 (FR1) or SSB/CORSET#0 multiplexing pattern 1, the frequency location and bandwidth of the second initial DL BWP is the same as the frequency location and bandwidth of the CORESET#0.

23. The method according to claim 21, wherein in the case of FR2 or SSB/CORSET#0 multiplexing pattern 2 or SSB/CORSET#0 multiplexing pattern 3, the frequency location and bandwidth of the second initial DL BWP is the same as the frequency location and bandwidth of the frequency span formed by the CD-SSB and the CORESENT#0.

24-27. (canceled)

28. A chip, comprising a processor and a communication interface, wherein the processor is configured to enable the chip to execute the method of claim 1.

29-31. (canceled)
